(19) United States
(12) Patent Application Publication
(10) Pub. No.: US 2017/0038963 A1
(43) Pub. Date: Feb. 9, 2017

(54) ELECTRONIC DEVICE

(71) Applicant: KYOCERA Corporation, Kyoto (JP)

(72) Inventor: Kenji KONO, Yokohama-shi, Kanagawa (JP)

(73) Assignee: KYOCERA Corporation, Kyoto (JP)

(21) Appl. No.: 15/100,170

(22) PCT Filed: Nov. 26, 2014
(86) PCT No.: PCT/JP2014/005921

§ 371 Date: May 27, 2016

(30) Foreign Application Priority Data
Nov. 28, 2013 (JP) 2013-246409

(51) Int. Cl. G06F 3/0488; G06F 3/0485; G06F 3/041; G06F 3/0484

(52) U.S. Cl. CPC G06F 3/04883; G06F 3/04842; G06F 3/0485; G06F 3/0418

(57) ABSTRACT

The electronic device (1) has a touch sensor (12) on the front face thereof, and includes a controller (14) configured to cancel, when a flick operation is performed while an object is being selected by an operation to the touch sensor (12) on the front face and the flick operation is accompanied by scrolling of screen, the flick operation.

### CROSS-REFERENCE TO RELATED APPLICATION

This application claims priority to and the benefit of Japanese Patent Application No. 2013-246409 filed on Nov. 28, 2013, the entire contents of which are incorporated herein by reference.

### TECHNICAL FIELD

This disclosure relates to an electronic device having a touch sensor.

### BACKGROUND

In recent years, there is an increase in electronic devices such as cell phones, or the like, having a touch sensor that detects contact by the user. As a contact detection type, various types of detection such as a resistive film type, a capacitive type, or the like, are known, and all of these types detect contact by a contacting object such as a user's finger, a stylus pen, or the like.

Furthermore, an electronic device having a touch sensor on the back face as well as on the front face thereof is known. For example, PTL 1 describes a mobile terminal having two touch sensors respectively on the front face and the back face thereof, and based on a predetermined correspondence relation associated with the operating state, an input to a first back face or a second back face is accepted as an input to a first front face or to a second front face, thereby allowing to increase convenience.

### CITATION LIST

### Patent Literature

PTL 1: JP2012-230567 (A)

### SUMMARY

### Technical Problem

In an electronic device such as a smart phone having a touch sensor, in general, selection is made by touching an object (a link such as application icon, browser, or the like) being displayed with a finger, and determination is made by removing the finger. In general, these selection and determination of an object are performed as a series of tap operation (operation of giving a slight press on a screen). Here, when the user notices that he/she has selected a wrong object by mistake, the user can cancel selection of the object by sliding his/her finger out of the range of the object selected by mistake before removing his/her finger.

Here, sliding of the finger to cancel the selection of the object may be erroneously detected as a flick operation (sweep (slide) a finger on a screen) accompanied by scrolling of screen. FIGS. 11A and 11B are diagrams illustrating an unnecessary scrolling of screen caused by a flick operation detected by mistake. In FIG. 11A, the user selects the icon H instead of the icon G, and slides his/her finger to the left to cancel the selection. At this time, when the electronic device detects the slide of the finger as a flick operation, scrolling of screen is performed as illustrated in FIG. 11B. Thus, in order for the user to select the target object, which is the icon G, an operation to return to the previous screen is needed.

This disclosure has been conceived in light of the above circumstances and provides an electronic device that allows prevention of an unnecessary scrolling of screen related to cancellation of selection of an object.

### Solution to Problem

In order to solve the above problem, the electronic device according to this disclosure is an electronic device that has a touch sensor on the front face thereof, and includes a controller configured to cancel, when a flick operation is performed while an object is being selected, by an operation to the touch sensor on the front face, and the flick operation is accompanied by scrolling of screen, the flick operation.

Furthermore, in order to solve the above problem, the electronic device according to this disclosure is an electronic device that has a touch sensor on the front face and back face thereof, and includes a controller configured to cancel, when a flick operation is performed by an operation to the touch sensor on the front face within a predetermined period of time after a screen is scrolled by an operation to the touch sensor on the back face, the flick operation.

### Advantageous Effect

According to this disclosure, an unnecessary scrolling of screen related to cancellation of selection of an object can be prevented.

### BRIEF DESCRIPTION OF THE DRAWINGS

In the accompanying drawings:

FIG. 1 is a block diagram illustrating a schematic configuration of an electronic device according to a first embodiment of this disclosure;

FIGS. 2A, 2B, and 2C are diagrams illustrating one example of a mounting structure of the electronic device according to the first embodiment of this disclosure;

FIGS. 3A and 3B are diagrams illustrating a state where the user holds the electronic device in his/her left hand;

FIG. 4 is a flow chart illustrating a processing of the electronic device related to a first cancellation operation of this disclosure;

FIG. 5 is a diagram illustrating the processing of the electronic device related to the first cancellation operation of this disclosure;

FIG. 6 is a flow chart illustrating a processing of the electronic device related to a second cancellation operation of this disclosure;

FIGS. 7A and 7B are diagrams illustrating the processing of the electronic device related to the second cancellation operation of this disclosure;

FIG. 8 is a block diagram of the electronic device according to the second embodiment of this disclosure;

FIGS. 9A, 9B, and 9C are diagrams illustrating one example of a mounting structure of the electronic device according to the second embodiment of this disclosure;

FIG. 10 is a block diagram illustrating a schematic configuration of an electronic device according to a third embodiment of this disclosure; and

FIGS. 11A and 11B are diagrams illustrating an unnecessary scrolling of screen related to cancellation of selection of an object.

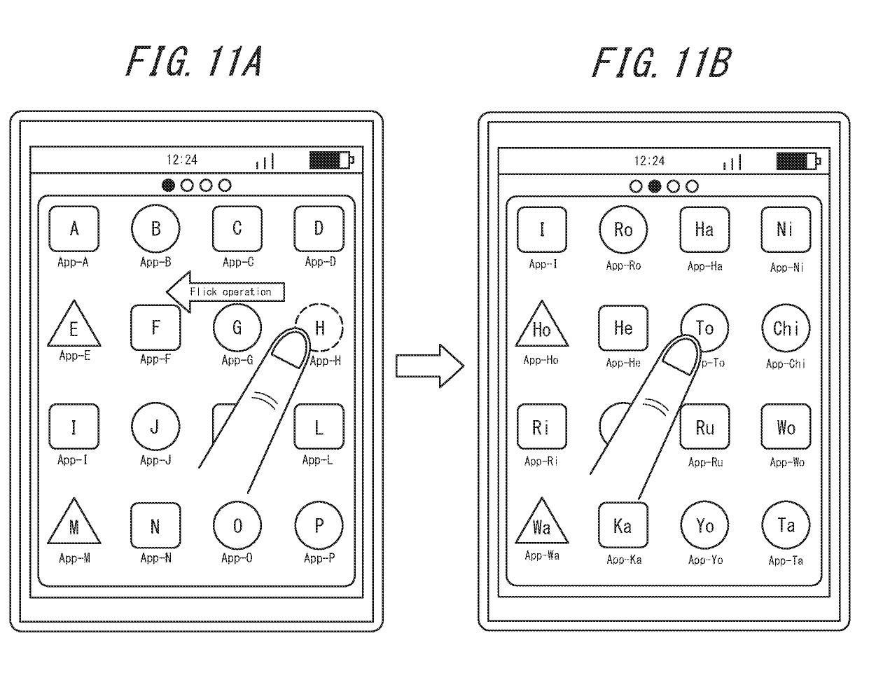

### DETAILED DESCRIPTION

The embodiments of this disclosure will be described in detail below with reference to the drawings.

### First Embodiment

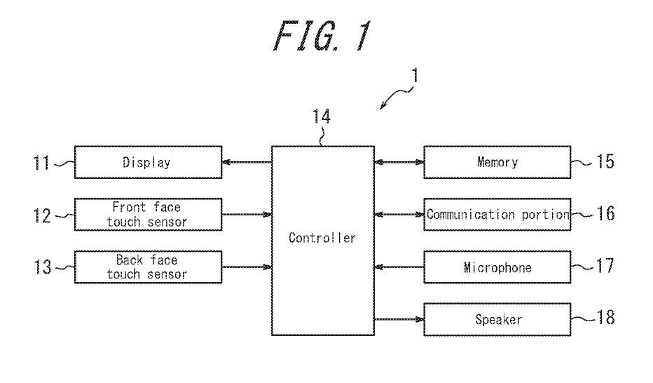

FIG. 1 is a block diagram illustrating a schematic configuration of an electronic device according to a first embodiment. In the example illustrated in FIG. 1, an electronic device 1 includes a display 11, a front face touch sensor 12, a back face touch sensor 13, a controller 14, a memory 15, a communication portion 16, a microphone 17 and a speaker 18.

The display 11 displays images such as characters, photographs, objects for operation, or the like. The display 11 is configured using a liquid crystal panel (LCD: Liquid Crystal Display), an organic EL panel (OELD: Organic Electroluminescence Display), or the like. For example, on the home screen, the display 11 displays objects for operation (object) that allow each operation such as telephone, mail, internet communication, shooting with a camera, or the like, to perform.

The front face touch sensor 12 detects, on the input screen thereof, contact by a finger or cancellation of the contact. Then the front face touch sensor 12 detects the position of contact on the input screen and outputs a signal indicating the position where the contact is detected to the controller 14. The front face touch sensor 12 is configured using a transparent member and is overlaid on the front face of the display 11. The user visually confirms the image on the display 11 via the transparent front face touch sensor 12, and operates the front face touch sensor 12 on the display position of the object for operation displayed by the display 11, thereby allowing the electronic device 1 to execute a predetermined processing. Here, the operation of the touch sensor refers to all operations such as touching, tapping, double tapping, flicking, or the like, by which a finger is allowed to come in contact with the touch sensor.

The back face touch sensor 13 is disposed on the back face of the electronic device 1 to improve operability when operating the electronic device 1, then detects, on the input face of the back face touch sensor 13, contact by a finger or cancellation of the contact, and outputs the detection result to the controller 14. The front face touch sensor 12 and the back face touch sensor 13 are realized by the known types such as, for example, a resistive film type, a capacitive type, or the like.

The controller 14 performs control according to the object for control displayed on the contact position when detecting the operation of the front face touch sensor 12 by the signal inputted from the front face touch sensor 12. In addition, the controller 14 can perform scrolling of screen when detecting a flick operation by the front face touch sensor 12.

The controller 14 performs control according to the input operation when detecting the operation of the back face touch sensor 13 by the signal inputted from the back face touch sensor 13. The controller 14 can perform scrolling of screen when detecting the flick operation by the back face touch sensor 13.

The memory 15 can be configured by a semiconductor memory, or the like, stores various information and a program for operating the electronic device 1, or the like, and serves as a work memory as well.

The communication portion 16 allows for communication with the base station or the other communication devices by wireless.

The microphone 17 collects ambient sound, such as utterance from the user. The sound collected by the microphone 17 is converted to electrical signals and is sent to the controller 14.

The speaker 18 outputs sound such as voice, music, ring tone, or the like.

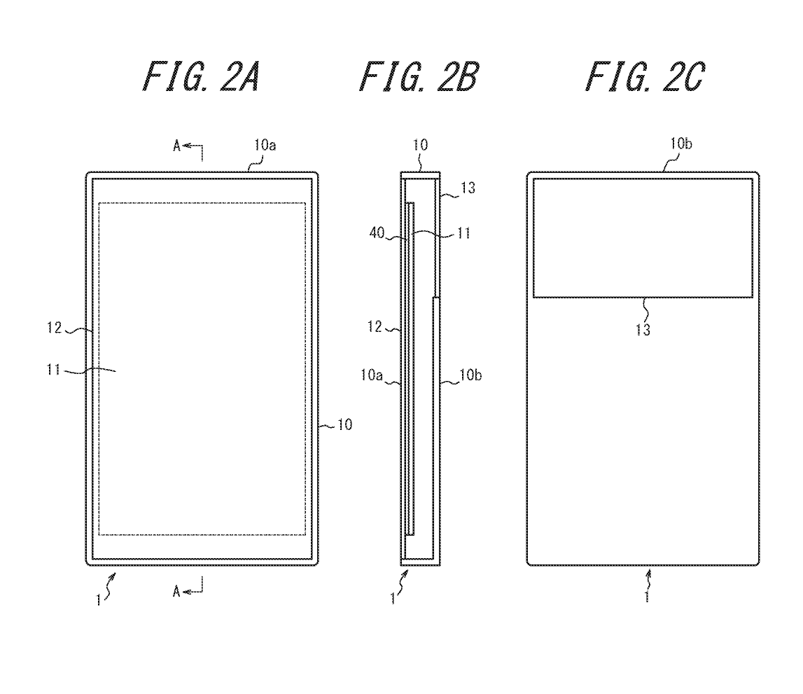

FIGS. 2A, 2B, and 2C are diagrams illustrating one example of a mounting structure of the electronic device 1 according to the first embodiment. FIG. 2A is a front view, FIG. 2B is a cross-sectional view taken from line A-A of FIG. 2A, and FIG. 2C is a back face view.

Note that, in FIGS. 2A through 2C, the elements other than the housing 10, the display 11, the front face touch sensor 12, the back face touch sensor 13 and a jointing member 40 are not illustrated. Besides the elements illustrated in FIGS. 2A through 2C, the electronic device 1 may include elements such as, for example, the controller 14, a substrate and various parts, or the like. Furthermore, typically, the microphone 17 is disposed below the front face touch sensor 12 and the speaker 18 is disposed above the front face touch sensor 12.

As illustrated in FIGS. 2A through 2C, the front face touch sensor 12 is disposed on the front face 10a of the housing 10 (e.g. a metal or resin case) and is supported by the housing 10.

The display 11 is disposed inside the housing 10. For example, the display 11 may be attached to the back of the front face touch sensor 12, directly fixed to the inside of the housing 10, or fixed to the substrate disposed inside the housing 10 or the holder for display. In FIGS. 2A through 2C, the display 11 is attached to the front face touch sensor 12 through the jointing member 40. As illustrated in FIG. 2B, with the display 11 disposed on the back side of the front face touch sensor 12, a user interface of one's choice is displayed on the display 11 when a touch panel is configured by the front face touch sensor 12 and the display 11, and the user operation can be detected by the front face touch sensor 12. Note that the jointing member 40 is a thermosetting or ultraviolet curable adhesive or double-sided tape, or the like, and may be, for example, an optical elastic resin, which is, for example, a colorless, transparent acrylic ultraviolet-curing type adhesive.

The back face touch sensor 13 is disposed on the back face 10b of the housing 10 such that it includes a range that can be touched by an index finger when the electronic device 1 is held by one hand, and is supported by the housing 10. For example, as illustrated in FIGS. 2B and 2C, the back face touch sensor 13 is disposed on the upper portion of the back face 10b of the housing 10.

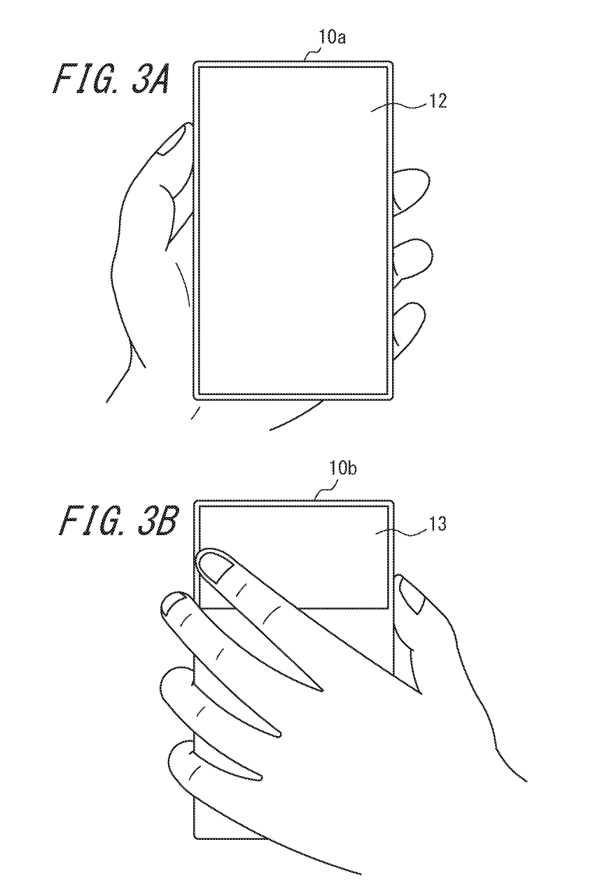

FIGS. 3A and 3B are diagrams illustrating a state where the user holds the electronic device 1 by his/her left hand. FIG. 3A is a diagram viewing from the front face side and FIG. 3B is a diagram viewing from the back face side. When the electronic device 1 is held by the left hand as illustrated in FIG. 3B, the index finger is located on the back face touch sensor 13. Thus, the user can operate (touch, tap, double tap, flick, or the like) the back face touch sensor 13 easily by just folding his/her index finger, without moving the other fingers. Note that, in this embodiment, although the back face touch sensor 13 is disposed exclusively on the position that can be touched by the index finger, it may be disposed over a wider range.

Hereinafter the processing by the electronic device 1 according to this disclosure will be described. The electronic device 1 prevents unnecessary scrolling of screen when the user cancels an object for operation that has been selected by mistake. Thus, when the electronic device 1 detects a flick operation under predetermined conditions, it executes the processing to cancel the flick operation.

(First Cancel Operation)

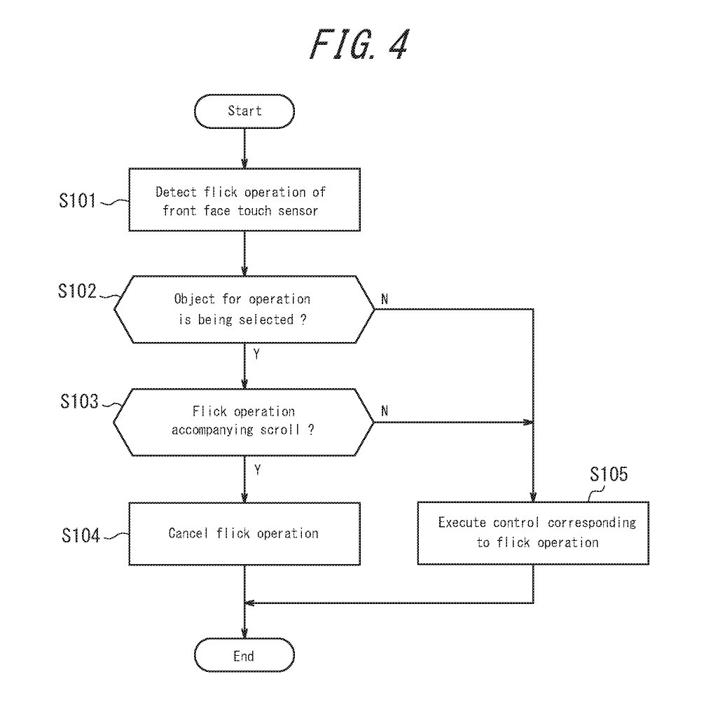

In the first cancel operation, when a flick operation accompanied by scrolling of screen is performed while an object for operation is being selected, such a flick operation is considered to be performed to cancel the selection of an object for operation, and the flick operation is cancelled. FIG. 4 is a flow chart illustrating the processing of the electronic device 1 related to the first cancel operation. When the controller 14 detects a flick operation to the front face touch sensor 12 by a signal inputted from the front face touch sensor 12 (step S101), it determines whether the object for operation is being selected or not (step S102). When the object for operation is being selected (Yes at step S102), the controller 14 detects whether the flick operation is a flick operation accompanied by scrolling of screen or not (step S103). When the controller 14 detects a flick operation accompanied by scrolling of screen while an object for operation is being selected (Yes at step S103), it cancels the flick operation and does not perform scrolling of screen (step S104). Note that, when an object for operation is not selected during detection of a flick operation (No at step S102) or the flick operation is not accompanied by scrolling of screen (No at step S103), the controller 14 performs control according to the flick operation (step S105).

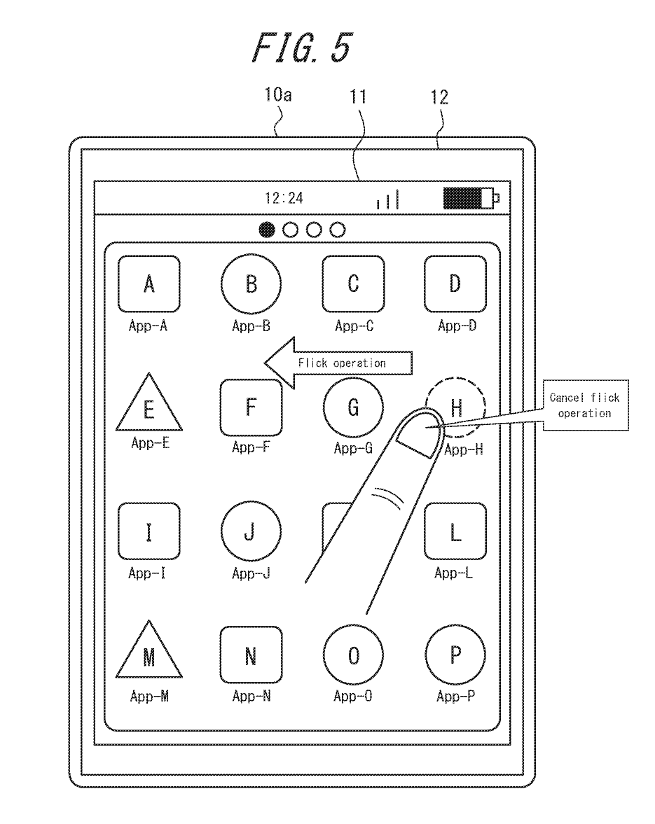

FIG. 5 is a diagram illustrating the processing of the electronic device related to the first cancel operation. In FIG. 5, the user selects the icon H for the icon G by mistake, and moves his/her finger to the left to cancel the selection. At this time, even if the controller 14 detects slide of the finger as a flick operation accompanied by scrolling of screen, since the icon H, which is an object for operation, is being selected, it cancels the flick operation and does not perform scrolling of screen.

Thus, when a flick operation is performed while an object for operation is being selected, by the operation to the front face touch sensor 12, the controller 14 cancels the flick operation if it is accompanied by scrolling of screen, thereby preventing unnecessary scrolling of screen related to cancellation of the selection of object. That is, after the selection of an object is cancelled, the user can select a correct object for operation while leaving the screen as it is, and thus the operability of the electronic device can be improved.

(Second Cancel Operation)

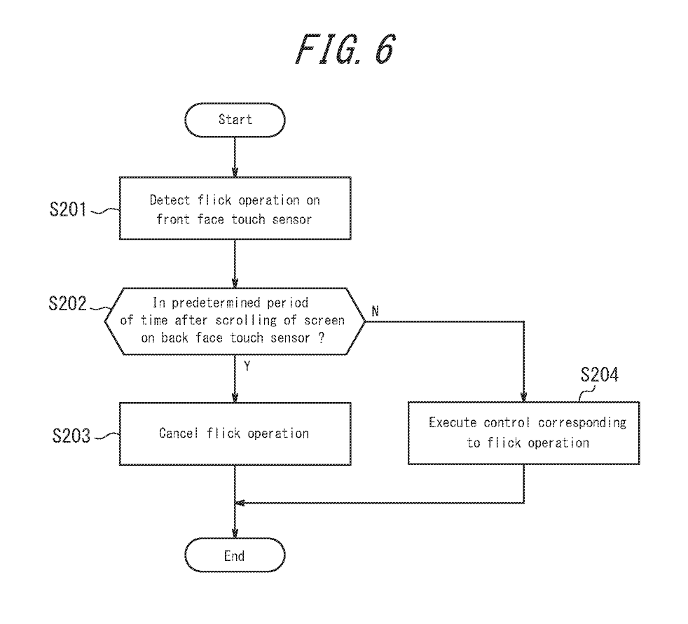

In the second cancel operation, a flick operation to the front face touch sensor 12 performed within a predetermined period of time after scrolling of screen is performed by the back face touch sensor 13 is cancelled. FIG. 6 is a flow chart illustrating a processing of the electronic device 1 related to the second cancel operation. When the controller 14 detects a flick operation to the front face touch sensor 12 by a signal inputted from the front face touch sensor 12 (step S201), it determines whether or not scrolling of screen by the back face touch sensor 13 is performed within a predetermined period of time (step S202). When scrolling of screen by the back face touch sensor 13 is performed within a predetermined period of time (Yes at step S202), the controller 14 cancels the flick operation (step S203). Note that, when scrolling of screen by the back face touch sensor 13 is not performed within a predetermined period of time (No at step S202), the controller 14 performs control according to the flick operation (step S204).

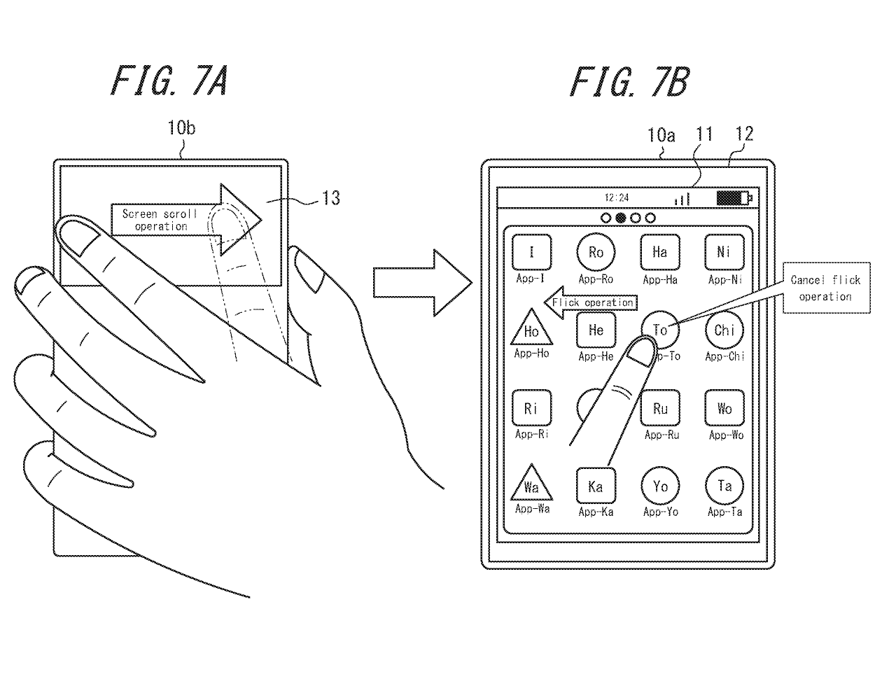

FIGS. 7A and 7B are diagrams illustrating the processing of the electronic device related to the second cancel operation. FIG. 7A is a diagram illustrating scrolling of screen by a flick operation to the back face touch sensor 13. In this case, as illustrated in FIG. 7B, even if the controller 14 detects a flick operation to the front face touch sensor 12 within a predetermined period of time after scrolling of screen by the back face touch sensor 13, it cancels the flick operation and does not perform scrolling of screen.

In this way, when a flick operation is performed by the operation to the front face touch sensor 12 within a predetermined period of time after scrolling of screen by the operation to the back face touch sensor 13, the controller 14 cancels the flick operation, thereby preventing unnecessary scrolling of screen related to cancellation of selection of the object. That is, after cancellation of selection of an object, the user can select a correct object for operation while leaving the screen as it is, thus the operability of the electronic device can be improved.

### Second Embodiment

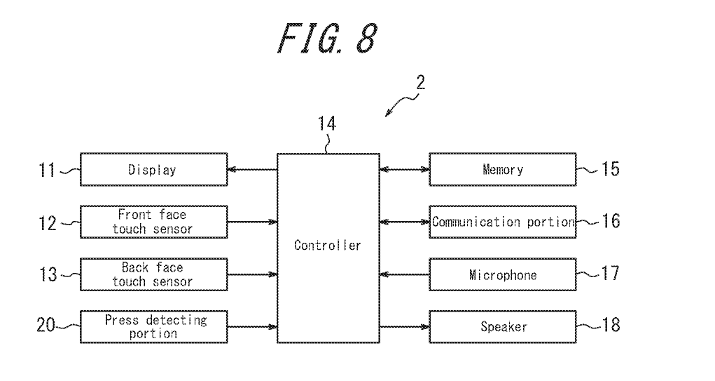

Next, the second embodiment of this disclosure will be described. FIG. 8 is a block diagram illustrating a schematic configuration of an electronic device according to the second embodiment of this disclosure. Compared to the electronic device 1 according to the first embodiment, the electronic device 2 according to the second embodiment further includes a press detecting portion 20. The other elements are the same as those of the first embodiment, thus the same reference signs are given and the explanation thereof is omitted.

The press detecting portion 20 detects a press when the user operates the back face touch sensor 13, and outputs the data based on press to the controller 14. The press detecting portion 20 is configured using, for example, a strain gauge sensor, a piezoelectric element, or the like, that experiences a change in physical or electrical characteristics (strain, resistance, voltage, or the like) according to a press. When the press detecting portion 20 is configured using, for example, a piezoelectric element, for the piezoelectric element of the press detecting portion 20, a voltage value (data based on press), which is electrical characteristics, changes according to the magnitude of load (force) (or the speed at which the magnitude of load changes (acceleration)) by a press to the back face touch sensor 13. Note that the data based on press can be, instead of a voltage value, magnitude of load by press, power value, resistance value, or the like.

Furthermore, the press detecting portion 20 may detect a press when the user operates the front face touch sensor 12 in the same way.

The controller 14 obtains the data based on press to the back face touch sensor 13 (and the front face touch sensor 12) from the press detecting portion 20. Then, when the data based on press is a predetermined threshold or more, the controller 14 determines that a predetermined operation has been performed, and controls such that a predetermined processing is performed according to the content of operation, for example, based on the application, or the like.

Moreover, the press detecting portion 20 may be configured according to the contact detection type. For example, when the contact detection type is a resistive film type, the magnitude of resistance according to the contact area is associated with the load of press to the touch face of the touch sensor, thereby constituting the press detecting portion 20 without using a strain gauge, a piezoelectric element, or the like. Alternatively, when the touch sensor is a capacitive type, the magnitude of capacitance is associated with the load of press to the touch sensor, thereby constituting without using a strain sensor, a piezoelectric element, or the like.

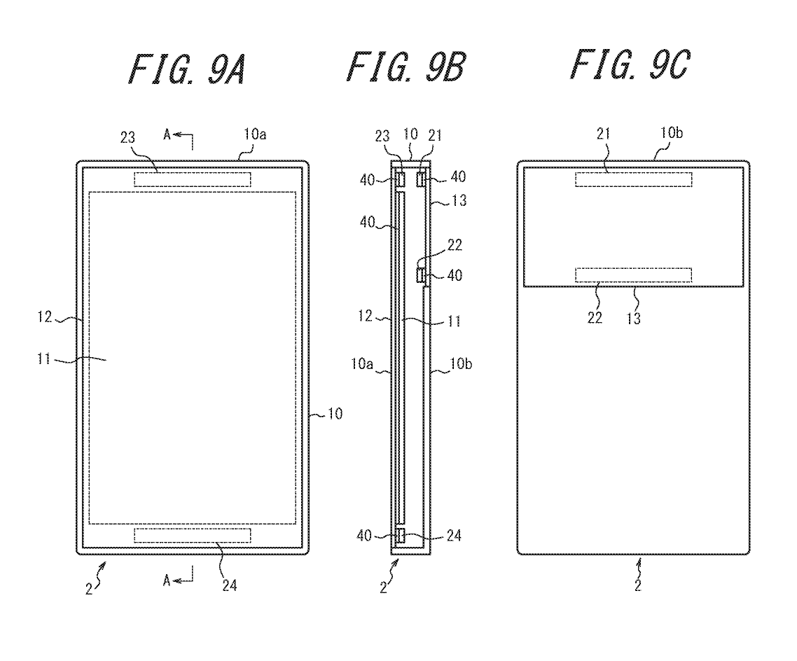

FIGS. 9A, 9B, and 9C are diagrams illustrating one example of a mounting structure of the electronic device 2 according to the second embodiment. FIG. 9A is a front view, FIG. 2B is a cross-sectional view taken from line A-A of FIG. 2A and FIG. 9C is a back view. Compared to the mounting structure of the electronic device 1 illustrated in FIGS. 2A through 2C, FIGS. 9A through 9C further illustrates piezoelectric elements 21 through 24 constituting the press detecting portion 20. Note that the number and the arrangement of the piezoelectric elements are not limited to the example illustrated.

In the example illustrated in FIGS. 9A through 9C, the press detecting portion 20 has a first piezoelectric element 21, a second piezoelectric element 22, a third piezoelectric element 23 and a fourth piezoelectric element 24, and with the first piezoelectric element 21 and the second piezoelectric element 22, a press by the user when he/she operates the back face touch sensor 13 is detected, and with the third piezoelectric element 23 and the fourth piezoelectric element 24, a press by the user when he/she operates the front face touch sensor 12 is detected.

Note that, in FIG. 9A, the area on the front face touch sensor 12 where the display by the display 11 is not required to be transmissive, that is, the area where the front face touch sensor 12 and the display 11 are not overlapped with each other, the area near the outside edge of the front face touch sensor 12 is preferably painted or covered by a bezel, thereby preventing the third piezoelectric element 23 and the fourth piezoelectric element 24, or the like, from being seen from outside of the electronic device 1.

The cancel operation of the electronic device 2 according to the second embodiment is performed along the flow charts illustrated in FIGS. 4 and 6, respectively, as in the case of the first embodiment. Note that, with respect to the detection of a flick operation at the step S101 and the step S201, the controller 14 may use the data based on press to the front face touch sensor 12 obtained from the press detecting portion 20. That is, the controller 14 can detect the operation to the front face touch sensor 12 as a flick operation when the data obtained from the press detecting portion 20 satisfies a predetermined threshold.

In this way, the electronic device 2 according to the second embodiment further includes the press detecting portion 20. Thus, the electronic device 2 can prevent a light touch with the other object from being determined as an operation by the user. In particular, when an electronic device is held, although a finger may come in contact with the touch sensor on the front face and the back face, a press is detected by the press detecting portion 20, thereby preventing an unintentional operation by the user from being erroneously determined as having been operated.

### Third Embodiment

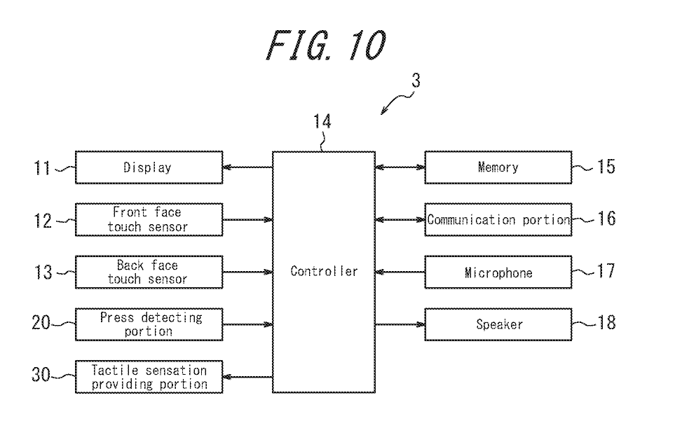

Next, the third embodiment of this disclosure will be described. FIG. 10 is a block diagram illustrating a schematic configuration of an electronic device according to the third embodiment of this disclosure. Compared to the electronic device 2 according to the second embodiment, the electronic device 3 according to the third embodiment further includes a tactile sensation providing portion 30. The other elements are the same as those of the second embodiment, thus the same reference signs are given and the explanation thereof is omitted.

The tactile sensation providing portion 30 generates a predetermined vibration based on a drive signal supplied from the controller 14. For the drive signal, it is sufficient if the drive signal generates a vibration emulating a vibration of a real button on the position where the finger touches.

The tactile sensation providing portion 30 is configured using a piezoelectric element, an ultrasonic vibrator, or a vibration motor (an eccentric motor), or the like, and generates vibration in a predetermined vibration pattern, thereby providing a tactile sensation to the user's finger that presses the back face touch sensor 13 to notify sensuously the user that the back face touch sensor 13 has been operated. The tactile sensation providing portion 30 may provide a tactile sensation to the user's finger that presses the back face touch sensor 13 by controlling charge on the film attached on the back face touch sensor 13, without using mechanical vibration.

Furthermore, the tactile sensation providing portion 30 may allow the front face touch sensor 12 to generate vibration in the same manner, to provide a tactile sensation to the user's finger that presses the front face touch sensor 12.

Note that the tactile sensation providing portion 30 may be configured integrally with the press detecting portion 20. In particular, when the press detecting portion 20 and the tactile sensation providing portion 30 are configured using a piezoelectric element, the piezoelectric element may be shared. This is because a piezoelectric element generates a voltage when a pressure is applied and is deformed when a voltage is applied. An example of the mounting structure in this case is as illustrated in FIGS. 9A through 9C.

When the press detecting portion 20 and the tactile sensation providing portion 30 are configured using a piezoelectric element, the controller 14 may perform a predetermined processing when the voltage value of the piezoelectric element satisfies a predetermined threshold and drive the piezoelectric element to generate vibration as well. Here, when the voltage value of the piezoelectric element satisfies a predetermined threshold can be when the voltage value reaches a predetermined reference value, when the voltage value exceeds a predetermined reference value, or when the voltage value equal to a predetermined reference value is detected.

As described above, the electronic device 3 according to the third embodiment further includes the tactile sensation providing portion 30 and generates a predetermined vibration based on a drive signal supplied from the controller 14. Thus, when the user operates the back face touch sensor 13 (and the front face touch sensor 12), the electronic device 3 can notify the user sensuously that an intentional operation has been performed.

Although the above described embodiments have been described as representative examples, it is apparent to those skilled in the art that many changes and replacements can be made within the spirit and the scope of this disclosure. Therefore, this disclosure should not be construed as limited by the above described embodiments, and various changes and modifications are possible without departing from the scope of claim. For example, a plurality of configuration blocks described in the embodiments may be combined into one, or one configuration block may be divided. Furthermore, in the present embodiment, note that various operations are executed by a dedicated circuit (e.g. individual logic gates interconnected to execute a specific function) mounted by a program command (software) or by a logic block, a program module, or the like, executed by one or more processors. One or more processors that execute a logic program, a program module, or the like, include, for example, one or more microprocessors, CPUs (Central Processing Unit), ASICs (Application Specific Integrated Circuit), DSPs (Digital Signal Processor), PLDs (Programmable Logic Device), FPGAs (Field Programmable Gate Array), processors, controllers, micro controllers, micro processors, electronic devices and other devices designed to allow the above described functions to be feasible and/or any combination thereof. The above described embodiments are mounted by, for example, hardware, software, firmware, middleware, micro code or any combination thereof. The command may be a program code or a code segment to execute a necessary task. Then, the command can be stored in a machine readable non-temporary storage media and other media. The code segment may indicate any combination of order, function, subprogram, program, routine, subroutine, module, software package, class or command, data structure or program statement. The code segment transmits/receives the information, data argument, variable, or memory content to/from the other code segment or hardware circuit, thereby allowing the code segment to be connected to the other code segment or the hardware circuit.

### REFERENCE SIGNS LIST

1, 2, 3 Electronic device
11 Display
12 Front face touch sensor
13 Back face touch sensor
14 Controller
15 Memory
16 Communication portion
17 Microphone
18 Speaker
20 Press detecting portion
21 First piezoelectric element
22 Second piezoelectric element
23 Third piezoelectric element
24 Fourth piezoelectric element
30 Tactile sensation providing portion
40 Jointing member

1. An electronic device having a touch sensor on a front face thereof, comprising a controller configured to cancel, when a flick operation is performed while an object is being selected by an operation to the touch sensor on the front face and the flick operation is accompanied by scrolling of screen, the flick operation.

2. An electronic device having a touch sensor on a front face and a back face thereof, comprising a controller configured to cancel, when a flick operation is performed by an operation to the touch sensor on the front face in a predetermined period of time after a screen is scrolled by an operation to the touch sensor on the back face, the flick operation.
